(19) United States
(12) Patent Application Publication
(10) Pub. No.: US 2022/0156769 A1
(43) Pub. Date: May 19, 2022

(54) DATA PROCESSING METHODS, APPARATUSES AND DEVICES, AND STORAGE MEDIA

(71) Applicant: Beijing Sensetime Technology Development Co., Ltd., Beijing (CN)

(72) Inventor: Xuecheng WANG, Beijing (CN)

(21) Appl. No.: 17/587,550

(22) Filed: Jan. 28, 2022

Related U.S. Application Data
(63) Continuation of application No. PCT/CN2021/076463, filed on Feb. 10, 2021.

(30) Foreign Application Priority Data
Jun. 30, 2020 (CN) 202010618809.6

(51) Int. Cl. G06Q 30/02; G06V 40/10; G06T 7/70; G06Q 10/06

(52) U.S. Cl. CPC G06Q 30/0202; G06Q 10/06312; G06T 7/70; G06V 40/10

(57) ABSTRACT

Methods, apparatuses, devices, and computer-readable storage media for data processing are provided. In one aspect, a computer-implemented method includes: obtaining video data of a first place, determining visit trajectories corresponding to multiple target persons according to the video data, and determining business data according to the visit trajectories.

### CROSS REFERENCE TO RELATED APPLICATIONS

This application is a continuation of International Application No. PCT/CN2021/076463, filed on Feb. 10, 2021, which claims priority to Chinese patent application No. 202010618809.6 entitled “DATA PROCESSING METHODS, APPARATUSES AND DEVICES, AND STORAGE MEDIA”, filed on Jun. 30, 2020, the entire contents of which are incorporated herein by reference.

### TECHNICAL FIELD

The present disclosure relates to the field of computer technologies, and in particular, to data processing methods, apparatuses and devices, and storage media.

### BACKGROUND

In offline sales scenarios such as hypermarkets, customer data statistics usually can be implemented with the help of captured video contents. Common customer data usually includes customer consumption data, visit data, and so on. At present, in combination with statistical results of the customer data and through manual data sorting and analysis, the overall situation of offline sales scenarios can be substantially learned. However, the above implementation method is time-consuming and labor-intensive, and it is difficult to accurately reflect the actual situation of offline sales scenarios.

### SUMMARY

In view of this, the present disclosure discloses a data processing method. The method includes: obtaining video data of a first place; determining visit trajectories corresponding to multiple target persons according to the video data; and determining business data according to the visit trajectories.

In an illustrated embodiment, after determining the business data, the method further includes: adjusting or deploying business distribution in a target place according to the business data.

In an illustrated embodiment, adjusting or deploying the business distribution in the target place according to the business data includes at least one of: adjusting the business distribution in the target place, where the target place includes the first place, or a second place other than the first place; or deploying business distribution in a third place other than the first place.

In an illustrated embodiment, the business data includes at least one of: data indicating an association relationship between different businesses; data indicating an association relationship between different sub-businesses in a same business; or data indicating an association relationship between sub-businesses belonging to different businesses.

In an illustrated embodiment, determining the business data according to the visit trajectories includes at least one of: determining, according to the visit trajectories, businesses visited by at least some of the multiple target persons within a first preset time period, and determining, according to the businesses visited by the at least some of the multiple target persons, a number of persons visiting each business combination, where the business combination is used to indicate two different businesses in the first place; or determining, according to the visit trajectories, sub-businesses visited by at least some of the multiple target persons within a second preset time period, and determining, according to the sub-businesses visited by the at least some of the multiple target persons, a number of persons visiting each business combination and/or each sub-business combination, where the sub-business combination is used to indicate two different sub-businesses in the first place.

In an illustrated embodiment, adjusting the business distribution in the target place according to the business data includes at least one of: increasing a number of businesses in the target place where a number of target persons who came to visit reaches a first threshold; reducing a number of businesses in the target place where a number of target persons who came to visit does not reach a second threshold; increasing a number of businesses that conform to attributes of target persons; or reducing a number of businesses that do not conform to attributes of target persons.

In an illustrated embodiment, after determining the business data, the method includes at least one of: determining businesses included in business combinations where a number of target persons who came to visit within the first preset time period reaches a third threshold as target businesses for linkage marketing; or determining sub-businesses included in sub-business combinations where a number of target persons who came to visit within the second preset time period reaches a fourth threshold as target sub-businesses for linkage marketing.

In an illustrated embodiment, the business data includes at least one of: data on target person flow comparison between business operation regions corresponding to respective businesses; data on target person flow comparison between respective businesses; data on target person flows corresponding to respective businesses within different time periods; data on target person flows corresponding to business operation regions corresponding to respective businesses within different time periods; data on a ratio of a number of target persons visiting business operation regions corresponding to respective businesses to a total number of target persons who came to visit; data on a ratio of a number of target persons visiting respective businesses to a total number of target persons who came to visit; data on a trend of target person flow changes corresponding to respective businesses; data on a trend of target person flow changes corresponding to business operation regions corresponding to respective businesses; data on attribute distribution of target persons visiting business operation regions corresponding to respective businesses; or data on attribute distribution of target persons visiting respective businesses.

In an illustrated embodiment, determining the visit trajectories corresponding to the multiple target persons according to the video data includes: identifying target persons appearing in multiple video streams corresponding to the first place; determining regions where the target persons are located in the multiple video streams; and reproducing visit trajectories corresponding to the target persons according to the determined regions.

In an illustrated embodiment, identifying the target persons appearing in the multiple video streams corresponding to the first place includes: extracting person features corresponding to persons appearing in the multiple video streams; obtaining person features matching the extracted person features from a person feature library; determining persons corresponding to the obtained person features matching the extracted person features as the target persons.

In an illustrated embodiment, determining the regions where the target persons are located in the multiple video streams includes: determining position coordinates of the target persons in a plane view including the first place based on calibration parameters of image capturing devices that capture target video streams, where the target video streams are those of the multiple video streams in which the target persons appear; determining regions corresponding to the position coordinates of the target persons in the plane view as the regions where the target persons are located in the multiple video streams.

In an illustrated embodiment, determining the regions where the target persons are located in the multiple video streams includes: determining, according to positions of image capturing devices that capture target video streams, regions corresponding to the image capturing devices, where the target video streams are those of the multiple video streams in which the target persons appear; determining the regions corresponding to the image capturing devices as the regions where the target persons are located in the multiple video streams.

In an illustrated embodiment, the method further includes: determining visiting time periods of the target persons visiting the regions according to capturing time information of the target video streams, where the target video streams are those of the multiple video streams in which the target persons appear.

In an illustrated embodiment, the first place includes at least one of commercial streets, shopping malls, hypermarkets or shops; the target persons include at least one of visitors, customers or members.

The present disclosure further provides a data processing apparatus. The apparatus includes: an obtaining module configured to obtain video data of a first place; a first determining module configured to determine visit trajectories corresponding to multiple target persons according to the video data; a second determining module configured to determine business data according to the visit trajectories.

In an illustrated embodiment, the apparatus further includes: an adjusting or deploying module configured to adjust or deploy business distribution in target place according to the business data.

In an illustrated embodiment, the adjusting or deploying module includes at least one of: an adjusting module configured to adjust the business distribution in the target place, where the target place includes the first place, or a second place other than the first place; or a deploying module configured to deploy business distribution in a third place other than the first place.

In an illustrated embodiment, the business data includes at least one of: data indicating an association relationship between different businesses; data indicating an association relationship between different sub-businesses in a same business; or data indicating an association relationship between sub-businesses belonging to different businesses.

In an illustrated embodiment, the second determining module includes at least one of a first determining submodule or a second determining submodule, where the first determining submodule is configured to determine, according to the visit trajectories, businesses visited by at least some of the multiple target persons within a first preset time period, and determine, according to the businesses visited by the at least some of the multiple target persons, a number of persons visiting each business combination, where the business combination is used to indicate two different businesses in the first place; or a second determining submodule configured to determine, according to the visit trajectories, sub-businesses visited by at least some of the multiple target persons within a second preset time period, and determine, according to the sub-businesses visited by the at least some of the multiple target persons, a number of persons visiting each business combination and/or each sub-business combination, where the sub-business combination is used to indicate two different sub-businesses in the first place.

In an illustrated embodiment, the adjusting or deploying module is configured to perform at least one of: increasing a number of businesses in the target place where a number of target persons who came to visit reaches a first threshold; reducing a number of businesses in the target place where a number of target persons who came to visit does not reach a second threshold; increasing a number of businesses that conform to attributes of target persons; or reducing a number of businesses that do not conform to attributes of target persons.

In an illustrated embodiment, the apparatus further includes at least one of: a third determining module configured to determine businesses included in business combinations where a number of target persons who came to visit within the first preset time period reaches a third threshold as target businesses for linkage marketing; or a fourth determining module configured to determine sub-businesses included in sub-business combinations where a number of target persons who came to visit within the second preset time period reaches a fourth threshold as target sub-businesses for linkage marketing.

In an illustrated embodiment, the business data includes at least one of: data on target person flow comparison between business operation regions corresponding to respective businesses; data on target person flow comparison between respective businesses; data on target person flows corresponding to respective businesses within different time periods; data on target person flows corresponding to business operation regions corresponding to respective businesses within different time periods; data on a ratio of a number of target persons visiting business operation regions corresponding to respective businesses to a total number of target persons who came to visit; data on a ratio of a number of target persons visiting respective businesses to a total number of target persons who came to visit; data on a trend of target person flow changes corresponding to respective businesses; data on a trend of target person flow changes corresponding to business operation regions corresponding to respective businesses; data on attribute distribution of target persons visiting business operation regions corresponding to respective businesses; or data on attribute distribution of target persons visiting respective businesses.

In an illustrated embodiment, the first determining module includes: an identifying module configured to identify target persons appearing in multiple video streams corresponding to the first place; a reproducing module configured to determine regions where the target persons are located in the multiple video streams, and reproduce visit trajectories corresponding to the target persons according to the determined regions.

In an illustrated embodiment, the identifying module includes: an extracting module configured to extract person features corresponding to persons appearing in the multiple video streams; an obtaining submodule configured to obtain person features matching the extracted person features from a person feature library; a target person determining module configured to determine persons corresponding to the matched person features as the target persons.

In an illustrated embodiment, the reproducing module includes: a first region determining module configured to determine position coordinates of the target persons in a plane view including the first place based on calibration parameters of image capturing devices that capture target video streams, where the target video streams are those of the multiple video streams in which the target persons appear, and determine regions corresponding to the position coordinates of the target persons in the plane view as the regions where the target persons are located in the video streams.

In an illustrated embodiment, the reproducing module includes: a second region determining module configured to determine, according to positions of image capturing devices that capture target video streams, regions corresponding to the image capturing devices, where the target video streams are those of the multiple video streams in which the target persons appear, and determine the regions corresponding to the image capturing devices as the regions where the target persons are located in the multiple video streams.

In an illustrated embodiment, the apparatus further includes: a time period determining module configured to determine visiting time periods of the target persons visiting the regions according to capturing time information of the target video streams, where the target video streams are those of the multiple video streams in which the target persons appear.

In an illustrated embodiment, the first place includes at least one of commercial streets, shopping malls, hypermarkets or shops; the target persons include at least one of visitors, customers or members.

The present disclosure further provides a computer readable storage medium. The storage medium stores a computer program. The computer program is executed by a processor to implement the data processing method according to any of the embodiments as described above.

The present disclosure further provides a data processing device. The device includes: a processor; and a memory for storing processor executable instructions. The processor is configured to call the executable instructions stored in the memory to implement the data processing method according to any of the embodiments as described above.

The present disclosure further provides a computer program. The computer program is stored in a storage medium. The computer program is executed by a processor to implement the data processing method according to any of the embodiments as described above.

It can be known from the above solution that the terminal device can determine the visit trajectories corresponding to multiple target persons according to the video data of the first place, and determine the business data according to the visit trajectories. Therefore, the process of data analysis that consumes a lot of human and material resources can be saved, that is, no manual participation is required, to obtain data that can reflect the overall situation of offline sales scenarios, that is, the business data. Moreover, because the business data is obtained mainly based on visit trajectories of persons, and the obtaining of the visit trajectories depends on actually captured video data of the first place, actual situations of the offline sales scenarios can be more accurately reflected.

It should be understood that the above general description and the following detailed description are only exemplary and explanatory and are not restrictive of the present disclosure.

### BRIEF DESCRIPTION OF THE DRAWINGS

In order to more clearly illustrate the technical solutions in one or more embodiments of the present disclosure or related arts, the drawings to be used in the description of the embodiments or related arts will be briefly introduced below. Obviously, the drawings in the following description are only some of examples described in one or more embodiments of the present disclosure. For those of ordinary skill in the art, according to these drawings, other drawings can be obtained without inventive efforts.

FIG. 1 is a flowchart illustrating a data processing method according to one or more embodiments of the present disclosure.

FIG. 2 is a flowchart illustrating a method for generating visit trajectories according to one or more embodiments of the present disclosure.

FIG. 3 is a schematic plane view illustrating a shopping mall according to one or more embodiments of the present disclosure.

FIG. 4 is a schematic diagram illustrating visit trajectories of customer 1 in a shopping mall according to one or more embodiments of the present disclosure.

FIG. 5 is a schematic diagram illustrating a customer flow matrix according to one or more embodiments of the present disclosure.

FIG. 6 is a structural diagram illustrating a data processing apparatus according to one or more embodiments of the present disclosure.

FIG. 7 is a structural diagram illustrating a data processing device according to one or more embodiments of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should be understood that the term “and/or” as used herein refers to and includes any and all possible combinations of one or more of the associated listed items. It should be further understood that depending on the context, the word “if” as used herein may be interpreted as “when” or “upon” or “in response to determining”.

In view of this, the present disclosure provides at least a data processing method. According to the method, visit trajectories of multiple target persons are determined, and business data is determined according to the visit trajectories, so that there is no need to manually participate in business data statistics, and efficiency and correctness of business data statistics can be further improved.

The technical solutions according to this application will be described below in conjunction with specific embodiments.

FIG. 1 is a flowchart illustrating a data processing method according to an embodiment of the present disclosure. As shown in FIG. 1, the method may include step S102 to step S106.

At S102, video data of a first place is obtained.

At S104, visit trajectories corresponding to multiple target persons are determined according to the video data.

At S106, business data is determined according to the visit trajectories.

The data processing method can be installed in any terminal device in the form of a software apparatus. For example, the terminal device may be a PC (Personal Computer) terminal, a mobile terminal, a PAD (Packet Assembler and Disassembler, which provides a terminal-to-host link service) terminal, etc. It will be understood that, when the method is implemented, the terminal device may provide a computing capability through a hardware chip installed therein. For example, the hardware chip may include an AI (Artificial Intelligence) chip, an FPGA (Field Programmable Gate Array), a CPU (Central Processing Unit), a GPU (Graphics Processing Unit), etc.

Below, the terminal device installed with the data processing method (hereinafter referred to as the “device”) will be used as an executive body for solution description. The terminal device has at least an image processing capability and a data statistics capability. The device may obtain video data of a first place, and then determine visit trajectories corresponding to multiple target persons according to the video data. After the visit trajectories corresponding to multiple target persons are obtained, the device may perform business data statistics according to the visit trajectories.

The first place may be an offline business operation place, and the first place includes several business operation regions, where each business operation region can correspond to the same or different businesses. In the first place, multiple image capturing devices (for example, cameras or camcorders) can be deployed for capturing video streams. The first place includes at least one of commercial streets, shopping malls, hypermarkets, shops, supermarkets, or the like.

For example, the first place may be a commercial street, and the business operation regions may be planned sales region in the commercial street.

For another example, the first place may be a shopping mall, and the business operation regions may be shops in the shopping mall.

For another example, the first place may be a supermarket, a retail store, or a shop deployed in a hypermarket, and the business operation regions may be counters that sells certain types of goods.

In an embodiment, the image capturing devices deployed in the first place can capture video streams in real time, and transmit the captured video streams to the terminal device for the terminal device to perform person flow statistics. It should be noted that the video streams can be transmitted to the terminal device in real time or within a specified time period. The specified time period may be a time period within which data transmission resources are sufficient, or the image capturing devices stop capturing the video streams.

The video data can be the video streams captured by multiple image capturing devices deployed in the first place, or video streams captured, for example, by a single panoramic camera, or a single image capturing device deployed in a small place such as a retail store. The video data usually includes multiple persons. In this application, by identifying target persons appearing in the video data, and determining regions where the target persons are located in the video data, then in combination with historical visited regions of the target persons, visit trajectories corresponding to the target persons are generated.

The visit trajectories may be visit trajectories of persons in the first place. The visit trajectories may indicate visited regions of the persons in the first place. For example, when the regions are shops, the visit trajectories may indicate visited shops of the persons.

In practical applications, the terminal device can maintain, for the target persons, a linked list indicating the visit trajectories. Whenever the terminal device determines the regions where the target persons are located, identifiers corresponding to the regions (for example, region identifiers or coordinate identifiers corresponding to the regions) can be filled into the linked list to maintain the visit trajectories.

The businesses may refer to business forms and states corresponding to the business operation regions.

For example, when the business forms and states corresponding to the business operation regions are classified by industries, the businesses can be classified into movie theaters, supermarkets, restaurants, cosmetics stores, bag stores, etc.

For another example, when the business forms and states corresponding to the business operation regions are classified by brands, the businesses can be classified according to production places, materials, uses, etc.

In an embodiment, in order to obtain more statistical data, the businesses may include several levels of sub-businesses. Two adjacent levels of businesses have an inclusion relationship therebetween.

For example, when a primary business includes restaurants, their corresponding sub-businesses (e.g., secondary businesses) can include Chinese food, Korean food, Shandong cuisine, Northeastern Chinese cuisine, Japanese food, etc.

Since the businesses include multiple levels of businesses, when business data statistics is performed, in addition to statistical data related to the primary businesses, statistical data related to the secondary businesses (sub-businesses) can be obtained so as to obtain more statistical data.

For example, the terminal device can determine the most popular restaurant sub-businesses or the like in the restaurant businesses.

The business data may include at least one of data indicating an association relationship between different businesses; data indicating an association relationship between different sub-businesses in a same business; data indicating an association relationship between sub-businesses belonging to different businesses.

Association relationships among multiple businesses can reflect an obvious or non-obvious relationship between two of the multiple businesses, and can further reflect obvious or non-obvious relationships among the multiple businesses as a whole. The obvious relationships refer to direct association relationships among the multiple businesses that can be learned from the data. The non-obvious relationships refer to indirect association relationships among the multiple businesses that can be obtained from data analysis and processing. Here, forms and types of data reflecting the association relationships among the multiple businesses are not limited, and may include, but are not limited to, the cases exemplified in the present disclosure.

The data indicating the association relationship between different businesses can effectively reflect an association relationship between two or even more businesses. For example, the data indicating the association relationship between different businesses can be data on customer flow comparison, opening hours, business linkage, attributes of visitors, etc. between different businesses. The data on business linkage refers to a number of persons who visited different businesses within a time period.

The data indicating the association relationship between different sub-businesses in the same business can effectively reflect an association relationship between two or even more different sub-businesses belonging to a same business. For example, the data indicating the association relationship between different sub-businesses can be data on customer flow comparison between different sub-businesses in a same business, opening hours of different sub-businesses in a same business, business linkage between different sub-businesses in a same business, attributes of visitors in different sub-businesses in a same business, etc.

The data indicating the association relationship between sub-businesses belonging to different businesses can effectively reflect an association relationship between two or even more different sub-businesses belonging to different businesses. For example, the data indicating the association relationship between sub-businesses belonging to different businesses can be data on customer flow comparison between sub-businesses in different businesses, opening hours of sub-businesses in different businesses, business linkage between sub-businesses in different businesses, attributes of visitors in sub-businesses in different businesses, etc. It should be noted that when there are three or even more sub-businesses involved, at least two of multiple sub-businesses involved belong to different businesses, which means that there may be multiple sub-businesses belonging to a same business.

When the business data statistics is performed, statistics can be performed on association relationship data between different businesses, between different sub-businesses in the same business, and between sub-businesses in different businesses. Therefore, statistics can be more accurately performed on true reflections of customers toward current business layouts to facilitate business adjustment or deployment.

In practical applications, the business data can be set according to actual business needs. For example, the business data includes at least one of data on target person flow comparison between business operation regions corresponding to respective businesses; data on target person flow comparison between respective businesses; data on target person flows corresponding to respective businesses within different time periods; data on target person flows corresponding to business operation regions corresponding to respective businesses within different time periods; data on a ratio of a number of target persons visiting business operation regions corresponding to respective businesses to a total number of target persons who came to visit; data on a ratio of a number of target persons visiting respective businesses to a total number of target persons who came to visit; data on a trend of target person flow changes corresponding to respective businesses; data on a trend of target person flow changes corresponding to business operation regions corresponding to respective businesses; data on attribute distribution of target persons visiting business operation regions corresponding to respective businesses; or data on attribute distribution of target persons visiting respective businesses.

Through business data statistics and analysis, the business layout of the target place can be adjusted or deployed.

It can be known from the above solution that the terminal device can determine the visit trajectories corresponding to multiple target persons according to the video data of the first place, and determine the business data according to the visit trajectories. Therefore, the process of data analysis that consumes a lot of human and material resources can be saved, that is, no manual participation is required, to obtain data that can reflect the overall situation of offline sales scenarios, that is, the business data. Moreover, because the business data is obtained mainly based on visit trajectories of persons, and the obtaining of the visit trajectories depends on actually captured video data of the first place, actual situations of the offline sales scenarios can be more accurately reflected.

In addition, since the business data statistics can be performed from various perspectives such as customer flow comparison and attributes of visitors between businesses, statistics can be more accurately performed on true reflections of customers toward current business layouts to facilitate business adjustment or deployment.

It should be noted that there are many methods for generating the visit trajectories, such as face identification technologies, WiFi probe technologies, and Person Re-identification technologies, which will not be exhaustively listed herein.

In an embodiment, in order to accurately reproduce the visit trajectories of persons, Person Re-identification (ReID) technologies may be used. The Person Re-identification technologies refer to technologies that use computer vision technologies to identify target persons appearing in an image or video stream. A method for reproducing visit trajectories based on a Person Re-identification technology will be introduced below.

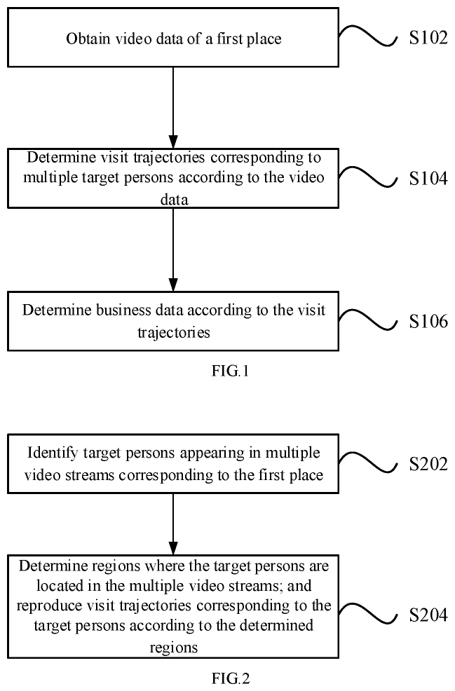

FIG. 2 is a flowchart illustrating a method for generating visit trajectories according to an embodiment of the present disclosure.

As shown in FIG. 2, the method may include step S202 to step S204.

At S202, target persons appearing in multiple video streams corresponding to the first place are identified.

At S204, regions where the target persons are located in the multiple video streams are determined, and the visit trajectories corresponding to the target persons are reproduced according to the determined regions.

The target persons are usually pre-specified persons. Before it is determined whether there are target persons in video streams through Person Re-identification technologies, the target persons usually need to be specified first. The target persons may include at least one of visitors, customers and members.

When the target persons are specified, usually, N clearer images including the target persons are stored in a target person library, so that person features corresponding to the target persons can be extracted from the target person library during person re-identification.

In an embodiment, from the captured video streams, M person images corresponding to persons appearing for the first time in the video streams may be selected, and the selected M person images may be stored in the target person library.

In another embodiment, N person images corresponding to the target persons may be obtained in other ways (for example, by downloading from a network), and the obtained N person images may be stored in the target person library.

When the target persons appearing in the video streams are identified based on the Person Re-identification technologies, the terminal device can first extract, from the multiple video streams, person features corresponding to persons appearing therein.

After the person features corresponding to the persons appearing in the multiple video streams are extracted, the terminal device can obtain person features matching the extracted person features from a person feature library.

Finally, the terminal device can determine persons corresponding to the matched person features as the target persons.

In practical applications, when person features appearing in the video streams are extracted therefrom, the video streams can be input into a pre-trained feature extraction network constructed based on a deep learning network (for example, a feature extraction network constructed based on a deep convolutional network or an attention mechanism network) to obtain person features corresponding to persons appearing in the video streams. The feature extraction network may be obtained by training based on several training samples.

It should be noted that the person features extracted from the video streams can include traditional image features such as Scale-invariant feature transform (SIFT) features in addition to the features extracted through the feature extraction network.

When the person features matching the extracted person features are obtained from the person feature library, in an embodiment, the terminal device can calculate similarities between the person features extracted from the video streams and person features maintained in the person feature library. Then, person features corresponding to the largest one of the obtained similarities are determined as person features matching the person features extracted from the video streams.

In another embodiment, the person feature library may not be directly maintained. Instead, a person image library is maintained. Therefore, when this step is performed, the person feature library needs to be constructed first. For example, the terminal device may first input person images maintained in the person image library into the feature extraction network to obtain several person features. Then, the terminal device can construct the person feature library based on the obtained several person features.

After the person feature library is obtained, the terminal device can calculate similarities between the person features extracted from the video streams and the person features maintained in the person feature library. Then, person features corresponding to the largest one of the obtained similarities are determined as person features matching the person features extracted from the video streams.

It should be noted that, in order to facilitate the calculation of similarities, the person features extracted from the video streams can have the same statistical dimension as the person features of the target persons maintained in the target person library. For example, if the person features maintained in the target person library include a 128-dimensional SIFT feature vector, when the person features are extracted from the video streams, the 128-dimensional SIFT feature vector is extracted.

In practical applications, when similarities between person features are calculated, distances between the extracted person features and the maintained person features of target persons can be calculated through cosine distances, Euclidean distances, Mahalanobis distances, etc., and the calculated distances are mapped into similarities (for example, mapped through normalization).

After the person features matching the extracted person features are obtained from the person feature library, persons corresponding to the matched person features may be determined as target persons.

It will be understood that the method exemplarily illustrates an implementation manner for the Person Re-identification technologies. In practical applications, specific implementation manners for the Person Re-identification technologies are diverse. The specific implementation manners for the Person Re-identification technologies will not be exhaustively listed herein.

When person features are extracted through the Person Re-identification technologies, in addition to person face features, more comprehensive features such as person postures, clothes and body shapes can be extracted to improve a capability of identifying the target persons from the video streams and accurately generate the visit trajectories corresponding to the target persons.

After the target persons appearing in the multiple video streams corresponding to the first place are identified based on the Person Re-identification technologies, the terminal device can determine the regions where the target persons are located in the video streams, and reproduce the visit trajectories corresponding to the target persons based on the determined regions.

In an embodiment, when the regions where the target persons are located in the video streams are determined, the terminal device may determine position coordinates of the target persons in a plane view including the first place based on calibration parameters of image capturing devices that capture target video streams. The target video streams are those of multiple video streams in which the target persons appear.

After the position coordinates of the target persons are determined, the terminal device may determine regions corresponding to the position coordinates of the target persons in the plane view as the regions where the target persons are located in the video streams.

The calibration parameters refer to intrinsic and extrinsic parameters calibrated for the image capturing devices, for example, focal lengths or pixels.

Based on the calibration parameters, world coordinates of the target persons can be determined, and then through relative position transformation, the position coordinates of the target persons in the plane view including the first place can be determined.

In another embodiment, when the regions where the target persons are located in the video streams are determined, the terminal device may determine regions corresponding to the image capturing devices that capture the target video streams according to positions of the image capturing devices. The target video streams are those of multiple video streams in which the target persons appear.

After the regions corresponding to the image capturing devices that capture the target video streams are determined, the terminal device may determine the regions corresponding to the image capturing devices that capture the target video streams as the regions where the target persons are located in the video streams.

It should be noted that methods for determining the regions where the target persons are located in the video streams may include other methods, which will not be exhaustively listed herein.

After the regions where the target persons are located in the video streams are determined, the terminal device may reproduce the visit trajectories corresponding to the target persons in combination with historical visited regions of the target persons.

In an embodiment, in order to obtain more statistical data of dimensions, after determining the regions where the target persons are located in the video streams, the terminal device may determine visiting time periods of the target persons visiting the regions according to capturing time information of the target video streams. The target video streams are those of multiple video streams in which the target persons appear.

In practical applications, the terminal device can obtain the visiting time periods of the target persons visiting the regions by subtracting a capturing time when the image capturing devices deployed in the regions identify the target persons for the first time from a capturing time when the image capturing devices deployed in the regions identify the target persons for the last time.

For example, assuming that camera A deployed in region A identifies target person A for the first time, current capturing time A can be recorded now. Then, the terminal device can start a timed task every time when the camera A identifies the target person A, and determine whether the camera A identifies the target person A again within a preset time period. If the camera A identifies the target person A again within the preset time period, the terminal device restarts the timed task. If the camera A does not identify the target person A again within the preset time period, the terminal device determines currently identified target person A as target person A identified by the camera for the last time, and records capturing time B when the target person A is identified for the last time. By subtracting the capturing time A from the capturing time B, the visiting time period of the target person A visiting the region A can be obtained.

Since the terminal device can perform statistics on the visiting time periods of the target persons visiting the regions, more statistical data can be obtained to perform corresponding analysis based on the more statistical data.

For example, the terminal device can analyze the most attractive region to persons in the first place in the dimension of the time periods for visiting the regions.

After the visit trajectories are determined, the terminal device may perform business data statistics based on the visit trajectories and businesses associated with visited regions indicated by the visit trajectories.

When the visit trajectories of the target persons are determined with the Person Re-identification technologies, according to the method, the target persons appearing in the multiple video streams corresponding to the first place can be identified based on the Person Re-identification technologies, then the regions where the target persons are located in the video streams are determined, the visit trajectories corresponding to the target persons are reproduced according to the determined regions, and the business data is determined according to the visit trajectories. Therefore, according to this method, all target persons appearing in the video streams can be accurately identified, and the visit trajectories of all target persons are accurately reproduced to improve the accuracy of business data statistics and provide reliable data for business layouts.

In an embodiment, after the business data is determined, the method may further include adjusting or deploying business distribution in the target place according to the business data.

In practical applications, after the business data statistics is completed, analysis data related to the business distribution can be obtained by analyzing the business data.

After the analysis data is obtained, the business distribution in the target place can be adjusted or deployed based on the analysis data.

In this embodiment, since the business distribution in the target place is adjusted or deployed according to the statistical business data, the business layouts in the target place can be made more consistent with actual situations indicated by the business data.

In an embodiment, when the business distribution in the target place is adjusted or deployed based on the business data, at least one of the following operations may be performed: adjusting the business distribution in the target place, where the target place includes the first place, and a second place other than (or different from) the first place; or deploying business distribution in a third place other than the first place.

The target place is a place of which business layout needs to be performed. The target place may include any place of which business layout needs to be performed.

In a situation, when businesses in the first place need to be adjusted, the first place is a target place. When the businesses in the target place are adjusted, the business adjustment can be completed according to business data statistics performed on the first place.

In practical applications, when the business distribution in the target place is adjusted based on the business data, any one or more of the following operations can be used: increasing a number of businesses in the target place where a number of target persons who came to visit reaches a first threshold; reducing a number of businesses in the target place where a number of target persons who came to visit does not reach a second threshold; increasing a number of businesses that conform to the attributes of the target persons; or reducing a number of businesses that do not conform to the attributes of the target persons.

For example, the business data includes at least data on target person flow comparison between respective businesses and/or between business operation regions corresponding to respective businesses. If it is found that there are a large number of shops for a business, and attracted customer flows thereof actually rank low, the number of shops for this business can be reduced. On the contrary, if it is found that there are a small number of shops for a business, and attracted customer flows thereof actually rank high, the number of shops for this business can be increased.

For another example, the business data includes at least data on target person flow comparison between respective businesses and/or between business operation regions corresponding to respective businesses, and data on attribute distribution of target persons visiting respective businesses and/or business operation regions corresponding to respective businesses. If it is found that most of customers visiting a business are men, and most of business shops in a mall are frequently visited by women customers, this kind of business shops can be reduced and replaced with other business shops that attract men customers, thereby increasing the shop conversion rate of customer flows in the mall.

In another situation, when businesses in the second place, where business layouts has been completed, other than the first place need to be adjusted, the second place is a target place (for its adjustment method, reference may be made to the relevant contents of the business adjustment in the first place, which will not be described in detail herein).

In still another situation, when businesses in the third place, where business layouts are not performed, other than the first place need to be deployed, the third place is a target place (for its deployment method, reference may be made to the relevant contents of the business adjustment in the first place, which will not be described in detail herein).

In this embodiment, since the business distribution in the target place is adjusted or deployed according to the statistical business data, the business layouts in the target place can be more consistent with actual situations indicated by the business data, which is beneficial to increase the shop conversion rate, where the shop conversion rate refers to a ratio of a number of persons who make purchases to a total number of visitors.

In an embodiment, determining the business data according to the visit trajectories may include: determining, according to the visit trajectories, businesses visited by at least some of the multiple target persons within a first preset time period; determining, according to the businesses visited by the at least some of the multiple target persons, a number of persons visiting each business combination, where the business combination is used to indicate two different businesses in the first place; and/or determining, according to the visit trajectories, sub-businesses visited by at least some of the multiple target persons within a second preset time period; determining, according to the sub-businesses visited by the at least some of the multiple target persons, a number of persons visiting each business combination and/or each sub-business combination, where the sub-business combination is used to indicate two different sub-businesses in the first place.

The business combination is used to indicate two different businesses in the first place. For example, when the first place includes a movie theater, restaurants, clothing stores, and other businesses, combinations of these businesses may include three combinations, namely, a combination of the movie theater and the restaurants, a combination of the movie theater and the clothing stores, and a combination of the restaurants and the clothing stores.

The sub-business combination is used to indicate two different sub-businesses in the first place. For example, when primary businesses included in the first place are clothing stores, they may include sub-businesses such as men clothing stores, women clothing stores, and children clothing stores. Here, combinations of these sub-businesses may include three combinations, namely, a combination of the men clothing stores and the women clothing stores, a combination of the men clothing stores and the children clothing stores, and a combination of the women clothing stores and the children clothing stores.

It should be noted that the sub-businesses included in the sub-business combination may belong to different primary businesses. For example, primary businesses included in the first place are clothing stores and restaurants. The clothing stores include two sub-businesses, namely, men clothing stores and women clothing stores. The restaurants include two sub-businesses, namely, Chinese food restaurants and Western food restaurants. Here, combinations of these sub-businesses may include six combinations, namely, a combination of the men clothing stores and the women clothing stores, a combination of the men clothing stores and the Chinese food restaurants, a combination of the men clothing stores and the Western food restaurants, a combination of the women clothing stores and the Chinese food restaurants, a combination of the women clothing stores and the Western food restaurants, and a combination of the Chinese food restaurants and the Western food restaurants.

After the number of persons visiting each business combination and/or each sub-business combination is determined, the method can further include at least one of: determining businesses included in business combinations where a number of target persons who came to visit within the first preset time period reaches a third threshold as target businesses for linkage marketing; or determining sub-businesses included in sub-business combinations where a number of target persons who came to visit within the second preset time period reaches a fourth threshold as target sub-businesses for linkage marketing.

The linkage marketing specifically refers to joint promotion marketing of multiple different businesses or sub-businesses with strong linkage. Different businesses with strong linkage refer to businesses included in business combinations where a number of target persons who came to visit within a time period reaches the third threshold.

For example, assuming that the third threshold is 100, a combination of businesses where a number of persons obtained through statistics reaches 100 is the combination of the restaurants and the movie theater. Here, when the linkage marketing is performed, the restaurants and the movie theater can be used as the target businesses for the linkage marketing. For example, a linkage marketing activity with a discount of 20% can be carried out when purchasing both of a restaurant service and a movie theater service within one day.

The first preset time period and the second preset time period can be set according to actual business requirements. For example, the first preset time period may be within one day (within 24 hours), and the second preset time period may be from 9 a.m. to 9 p.m.

It should be noted that, for the linkage marketing of the target sub-businesses, reference may be made to the description of the linkage marketing for the target businesses, which will not be described in detail herein.

In the above-mentioned solution, since the businesses included in the business combinations where the number of target persons who came to visit within the first preset time period reaches the third threshold are determined as the target businesses for linkage marketing, and the sub-businesses included in the sub-business combinations where the number of target persons who came to visit within the second preset time period reaches the fourth threshold are determined as the target sub-businesses for linkage marketing, the linkage marketing can be accurately performed on the businesses with strong linkage, and thus the shop conversion rate can be increased.

The embodiments of the present disclosure are described below in conjunction with offline retail scenarios.

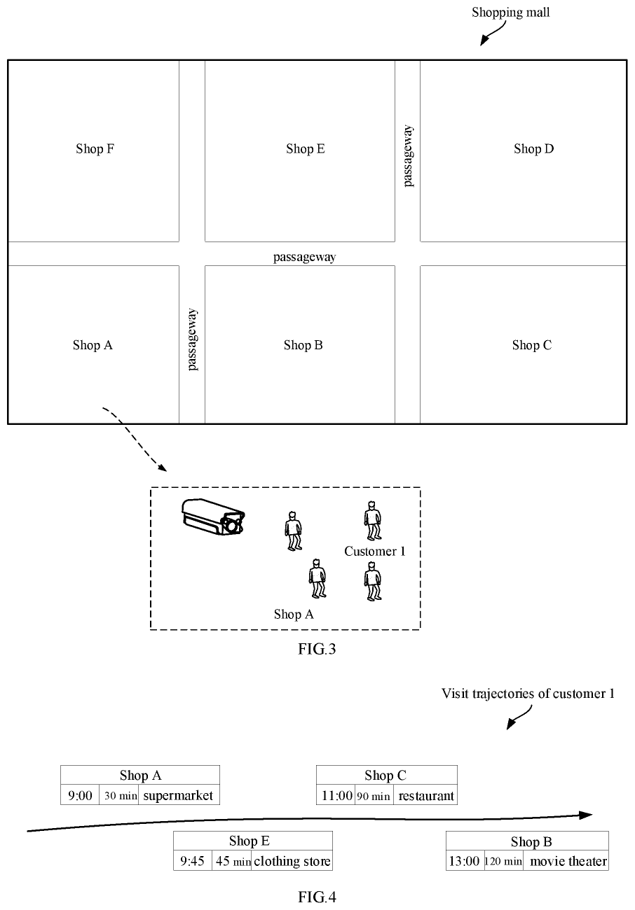

FIG. 3 is a schematic plane view illustrating a shopping mall according to an embodiment of the present disclosure. As shown in FIG. 3, the shopping mall includes a total of 6 shops (business operation regions) from shop A to shop F. The shop A is a supermarket (primary business). The shop B is a movie theater (primary business). The shop C is a Chinese food restaurant (secondary sub-business). The shop D is a Korean food restaurant (secondary sub-business). The shop E is a clothing store (primary business). The shop F is a gymnasium (primary business). The primary business of the shops C and D is restaurants.

Each shop is deployed with a camera, and the camera is in communication with a customer flow statistics device (hereinafter referred to as “the device”). The device is installed with the data processing method disclosed in any of the above-mentioned embodiments. The device can obtain video streams captured by the camera in real time.

Assuming that customer 1 first visited the shop A at 9:00 after entering the mall, at this time, the device can identify the customer 1 appeared in video streams captured by camera A deployed in the shop A based on Person Re-identification technologies.

Then, the device can subtract 9:00 from a time (which is assumed to be 9:30) when the camera A captured the customer 1 for the last time to obtain that a visiting time period of the customer 1 visiting the shop A was 30 minutes.

Finally, the device can maintain, to visit trajectories corresponding to the customer 1, the shop A, the time when the shop A is visited, the visiting time period of visiting the shop A, and attributes of the supermarket corresponding to the shop A.

Here, the visit trajectories corresponding to the customer 1 can indicate at least that the customer 1 visited the shop A at 9:00, and the visiting time period was 30 minutes.

By analogy, the device will accurately reproduce the visit trajectories of the customer 1 in the shopping mall.

FIG. 4 is a schematic diagram illustrating visit trajectories of a customer in a shopping mall according to an embodiment of the present disclosure.

As shown in FIG. 4, customer 1 stayed at shop A (supermarket) at 9 o'clock for 30 minutes. Then, the customer 1 went to shop E (clothing store) at 9:45 and stayed at the shop E for 40 minutes. The customer 1 went to shop C (Chinese food restaurant) at 11:00 and stayed at the shop C for 1 hour and 30 minutes. Finally, the customer 1 went to shop B (movie theater) at 13:00 and stayed at the shop B for 2 hours.

It should be noted that the schematic diagram of the visit trajectories is only exemplarily illustrative. In practical applications, there may be multiple storage forms, which will not be limited here.

Similarly, the device can identify all customers appearing in the shopping mall, and maintain visit trajectories of each customer in the shopping mall.

Regularly, the device may perform customer flow statistics according to visit trajectories and businesses associated with visited shops indicated by the visit trajectories.

In an embodiment, the device can perform statistics on customer flows of each of the shop A to the shop F within one day, that is, customer flows of businesses such as supermarkets, clothing stores, gymnasiums, and movie theaters within one day, and customer flows of Chinese food restaurants and Korean food restaurants within one day.

In an embodiment, statistics can be performed on any one or more of: data on customer flow comparison between respective business operation regions; data on customer flow comparison between respective businesses; data on customer flows corresponding to respective businesses within different time periods; data on customer flows corresponding to respective business operation regions within different time periods; a ratio of a number of customers visiting respective business operation regions to a total number of customers who came to visit; a ratio of a number of customers visiting respective businesses to a total number of customers who came to visit; a trend of customer flow changes corresponding to respective businesses; a trend of customer flow changes corresponding to respective business operation regions; person attribute distribution of customers visiting respective business operation regions; or person attribute distribution of customers visiting respective businesses.

It should be noted that the business data can be other indexes, and the business data will not be exhaustively listed herein.

The comparison data refers to comparison between customer flows corresponding to different regions or businesses. For example, if 100 persons visited business A, and 90 persons visited business B, there is a difference of 10 persons between the number of persons visiting the business A and the number of persons visiting the business B.

When the data on customer flow comparison between respective business operation regions is determined, statistical data on customer flows of each of shop A to shop F within one day is put in a chart to intuitively display the data on customer flow comparison between respective business operation regions.

When the data on customer flow comparison between respective businesses is determined, statistical data on customer flows of businesses such as restaurants, supermarkets, clothing stores, gymnasiums, and movie theaters within one day is put in a chart to intuitively display the data on customer flow comparison between respective businesses. When the data on customer flows corresponding to respective businesses within different time periods is determined, statistics can be performed by time on data on customer flows of businesses such as restaurants, supermarkets, clothing stores, gymnasiums, and movie theaters within one day to display data indexes on customer flows corresponding to respective businesses within different time periods.

When the data on customer flows corresponding to respective business operation regions within different time periods is determined, statistics can be performed by time on data on customer flows of each of shop A to shop F within one day to display data indexes on customer flows corresponding to respective business operation regions within different time periods.

When the ratio of a number of customers visiting respective business operation regions to a total number of customers who came to visit is determined, statistical data on customer flows of each of shop A to shop F within one day is used as numerators, and a total number of customers visiting the shopping mall on the day is used as a denominator to calculate the ratio of a number of customers visiting respective business operation regions to a total number of customers who came to visit.

When the ratio of a number of customers visiting respective businesses to a total number of customers who came to visit is determined, statistical data on customer flows of businesses such as restaurants, supermarkets, clothing stores, gymnasiums, and movie theaters within one day is used as numerators, and a total number of customers visiting the shopping mall on the day is used as a denominator to calculate the ratio of a number of customers visiting respective businesses to a total number of customers who came to visit.

The data on a trend of target person flow changes refers to changes in customer flows over time. For example, from 9 a.m. to 10 a.m., an hourly customer flow of shop A changes from 100 persons to 80 persons.

When the trend of customer flow changes corresponding to respective businesses is determined, statistics can be performed by time on data on customer flows of businesses such as restaurants, supermarkets, clothing stores, gymnasiums, and movie theaters within one day, and then the statistical data is summarized in a chart in chronological order to intuitively display the trend of customer flow changes corresponding to respective businesses.

When the trend of customer flow changes corresponding to respective business operation regions is determined, statistics can be performed by time on data on customer flows of each of shop A to shop F within one day, and then the statistical data is summarized in a chart in chronological order to intuitively display the trend of customer flow changes corresponding to respective business operation regions.

The data on person attribute distribution refers to distribution of attributes possessed by persons who visit respective businesses or regions. For example, attribute distribution of persons visiting business A involves men, which are 20-35 years old, casually dressed, etc.

When the data on person attribute distribution of customers visiting respective business operation regions is determined, person attributes (for example, features that can reflect person appearances, such as genders, ages, and clothes) of customers visiting each of shop A to shop F within one day can be identified through an attribute identification network built based on a neural network to determine person attributes possessed by customers who visit respective business operation regions.

When the data on person attribute distribution of customers visiting respective businesses is determined, person attributes of customers visiting businesses such as restaurants, supermarkets, clothing stores, gymnasiums, and movie theaters within one day can be identified through an attribute identification network built based on a neural network to determine person attributes possessed by customers who visit respective business operation regions.

It will be understood that when the business data related to businesses is determined, the related business data can be determined based on statistical customer flows of Chinese food restaurants and Korean food restaurants within one day, which will not be described in detail herein.

After the business data is obtained, the customer flow statistics device can output the business data to an administrator, so that the administrator can determine a business strategy based on the business data.

In practical applications, after the business data is obtained, the customer flow statistics device can output the business data through a display interface that interacts with the administrator, so that the administrator can decide how to lay out the businesses.

For example, the administrator can understand and monitor distribution of customer flows in respective businesses in the shopping mall based on basic data statistics of the businesses, and can adjust and optimize business distribution in time in combination with a number and positions of shops for the businesses. If it is found that there is a larger number of shops F (gymnasiums), and attracted customer flows thereof are actually smaller, the business shops can be reduced and replaced with other shops that attract more customers (for example, restaurants), thereby increasing the shop conversion rate of customer flows in the mall.

It should be noted that the business strategy can be determined by the administrator based on actual situations, which will not be exhaustively listed herein.

In an embodiment, the step of determining the business strategy can be completed in the customer flow statistics device, so that the efficiency of confirming the business strategy and the use experiences of persons can be improved without participation of the administrator.

In practical applications, the customer flow statistics device can analyze the business data and output the business strategy for the shopping mall. The business strategy includes planning and layout schemes for business operation regions or businesses.

In an embodiment, in order to analyze more business strategies, the customer flow statistics device can perform statistics on a number of customers visiting business operation regions corresponding to multiple target businesses at the same time within a preset time period.

In practical applications, the customer flow statistics device can perform statistics on a number of customers visiting business operation regions corresponding to two target businesses at the same time within one day.

For example, the customer flow statistics device can maintain a customer flow matrix. Rows and columns of the customer flow matrix respectively indicate different businesses. Elements of the customer flow matrix may indicate a number of customers visiting businesses indicated by rows and columns where the elements are located at the same time within one day.

FIG. 5 is a schematic diagram illustrating a customer flow matrix according to an embodiment of the present disclosure. As shown in FIG. 5, rows and columns of the customer flow matrix indicate five businesses, namely, restaurants (abbreviated as RT), supermarkets (abbreviated as SM), clothing stores (abbreviated as CS), gymnasiums (abbreviated as GYM), and movie theaters (abbreviated as MT). Element A indicates a number of customers visiting the restaurants and the movie theaters at the same time within one day.

When statistics is performed on a number of customers visiting business operation regions corresponding to two target businesses at the same time within one day, the customer flow statistics device can determine, based on visit trajectories and the businesses, businesses corresponding to business operation regions visited by target persons within a preset time period. Then, the customer flow statistics device can combine two of the determined businesses to obtain several business combinations. Finally, the customer flow statistics device can update a number of customers visiting the businesses in the business combinations at the same time.

Continuing to refer to FIG. 4, it is assumed that visit trajectories of customer 1 are: the customer 1 stayed at shop A at 9 o'clock for 30 minutes, then the customer 1 went to shop E at 9:45 and stayed at the shop E for 40 minutes, the customer 1 went to shop C at 11:00 and stayed at the shop C for 1 hour and 30 minutes, and finally, the customer 1 went to shop B at 13:00 and stayed at the shop B for 2 hours.

The customer flow statistics device can determine that business combinations visited by the customer 1 on that day may include a combination of the supermarkets and the clothing stores, a combination of the supermarkets and the restaurants, a combination of the supermarkets and the movie theaters, a combination of the clothing stores and the restaurants, and a combination of the clothing stores and the movie theaters, and a combination of the restaurants and the movie theaters.

After the business combinations visited by the customer 1 on that day are determined, the customer flow statistics device can search for elements corresponding to each business combination in the customer flow matrix maintained by the customer flow statistics device, and add 1 to numerals indicated by the elements.

For example, for the combination of the restaurants and the movie theaters, element A in the customer flow matrix as shown in FIG. 4 can be determined, and then the customer flow statistics device can add 1 to numerals indicated by the element A.

Since the customer flow statistics device can perform statistics on a number of customers visiting business operation regions corresponding to multiple target businesses at the same time within a preset time period, more business strategies can be analyzed.

For example, based on the customer flow statistics device that can perform statistics on a number of customers visiting business operation regions corresponding to multiple target businesses at the same time within a preset time period, the administrator can analyze linkage between businesses (if there are a larger number of customers who came to visit at the same time within one day, it is indicated that the linkage between businesses is stronger) to provide data guidance for linkage marketing plans (business strategies). If it is found that linkage between the restaurants and the movie theaters is stronger, a manner “providing a 20% discount if consuming in both a restaurant and a movie theater” can be taken into consideration to promote the conversion rate of customers.

It should be noted that the business strategies can be determined by the administrator based on actual situations, which will not be exhaustively listed herein.

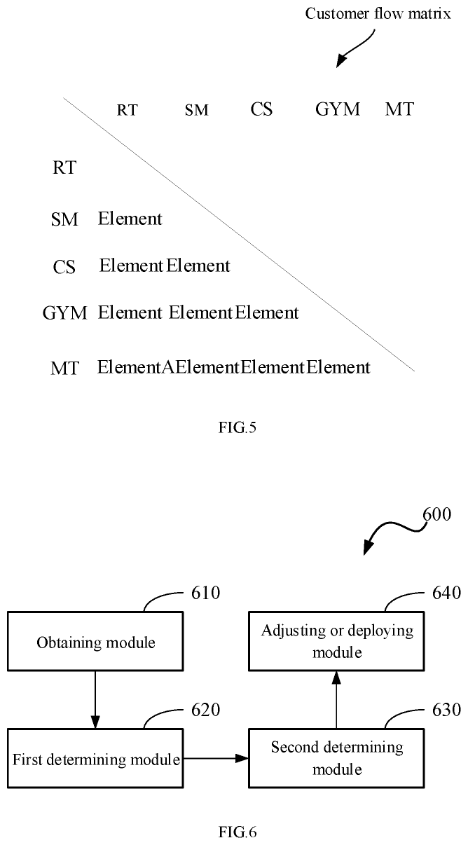

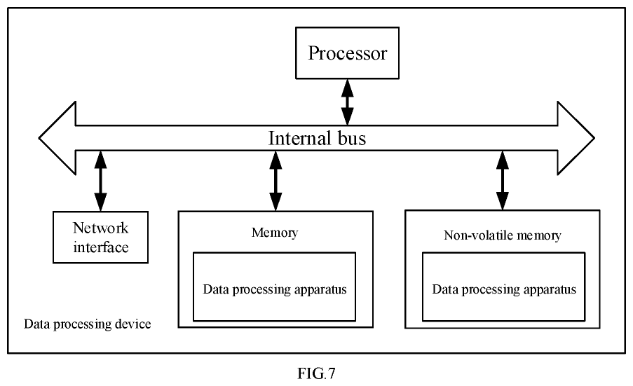

The present disclosure further provides a data processing apparatus. FIG. 6 is a structural diagram illustrating a data processing apparatus according to the present disclosure.

As shown in FIG. 6, an apparatus 600 includes: an obtaining module 610 configured to obtain video data of a first place; a first determining module 620 configured to determine visit trajectories corresponding to multiple target persons according to the video data; a second determining module 630 configured to determine business data according to the visit trajectories.

In an illustrated embodiment, the apparatus 600 further includes: an adjusting or deploying module 640 configured to adjust or deploy business distribution in a target place according to the business data.

In an illustrated embodiment, the adjusting or deploying module includes at least one of: an adjusting module configured to adjust the business distribution in the target place, where the target place includes the first place, or a second place other than the first place; or a deploying module configured to deploy business distribution in a third place other than the first place.

In an illustrated embodiment, the business data includes at least one of: data indicating an association relationship between different businesses; data indicating an association relationship between different sub-businesses in a same business; or data indicating an association relationship between sub-businesses belonging to different businesses.

In an illustrated embodiment, the second determining module 630 includes at least one of a first determining submodule or a second determining submodule.

The first determining submodule is configured to determine, according to the visit trajectories, businesses visited by at least some of the multiple target persons within a first preset time period, and determine, according to the businesses visited by the at least some of the multiple target persons, a number of persons visiting each business combination, where the business combination is used to indicate two different businesses in the first place.

The second determining submodule is configured to determine, according to the visit trajectories, sub-businesses visited by at least some of the multiple target persons within a second preset time period, and determine, according to the sub-businesses visited by the at least some of the multiple target persons, a number of persons visiting each business combination and/or each sub-business combination, where the sub-business combination is used to indicate two different sub-businesses in the first place.

In an illustrated embodiment, the adjusting or deploying module 640 is configured to perform at least one of: increasing a number of businesses in the target place where a number of target persons who came to visit reaches a first threshold; reducing a number of businesses in the target place where a number of target persons who came to visit does not reach a second threshold; increasing a number of businesses that conform to attributes of target persons; or reducing a number of businesses that do not conform to attributes of target persons.

In an illustrated embodiment, the apparatus 600 further includes at least one of: a third determining module configured to determine businesses included in business combinations where a number of target persons who came to visit within the first preset time period reaches a third threshold as target businesses for linkage marketing; or a fourth determining module configured to determine sub-businesses included in sub-business combinations where a number of target persons who came to visit within the second preset time period reaches a fourth threshold as target sub-businesses for linkage marketing.

In an illustrated embodiment, the business data includes at least one of: data on target person flow comparison between business operation regions corresponding to respective businesses; data on target person flow comparison between respective businesses; data on target person flows corresponding to respective businesses within different time periods; data on target person flows corresponding to business operation regions corresponding to respective businesses within different time periods; data on a ratio of a number of target persons visiting business operation regions corresponding to respective businesses to a total number of target persons who came to visit; data on a ratio of a number of target persons visiting respective businesses to a total number of target persons who came to visit; data on a trend of target person flow changes corresponding to respective businesses; data on a trend of target person flow changes corresponding to business operation regions corresponding to respective businesses; data on attribute distribution of target persons visiting business operation regions corresponding to respective businesses; or data on attribute distribution of target persons visiting respective businesses.

In an illustrated embodiment, the first determining module 620 includes: an identifying module configured to identify target persons appearing in multiple video streams corresponding to the first place; a reproducing module configured to determine regions where the target persons are located in the multiple video streams, and reproduce visit trajectories corresponding to the target persons according to the determined regions.

In an illustrated embodiment, the identifying module includes: an extracting module configured to extract person features corresponding to persons appearing in the multiple video streams; an obtaining submodule configured to obtain person features matching the extracted person features from a person feature library; a target person determining module configured to determine persons corresponding to the matched person features as the target persons.

In an illustrated embodiment, the reproducing module includes: a first region determining module configured to determine position coordinates of the target persons in a plane view including the first place based on calibration parameters of image capturing devices that capture target video streams, where the target video streams are those of the multiple video streams in which the target persons appear, and determine regions corresponding to the position coordinates of the target persons in the plane view as the regions where the target persons are located in the video streams.

In an illustrated embodiment, the reproducing module includes: a second region determining module configured to determine, according to positions of image capturing devices that capture target video streams, regions corresponding to the image capturing devices, where the target video streams are those of the multiple video streams in which the target persons appear, and determine the regions corresponding to the image capturing devices as the regions where the target persons are located in the multiple video streams.

In an illustrated embodiment, the apparatus 600 further includes: a time period determining module configured to determine visiting time periods of the target persons visiting the regions according to capturing time information of the target video streams, where the target video streams are those of the multiple video streams in which the target persons appear.

In an illustrated embodiment, the first place includes at least one of commercial streets, shopping malls, hypermarkets or shops; the target persons include at least one of visitors, customers or members.

The embodiments of the data processing apparatus shown in the present disclosure can be applied to a data processing device. The apparatus embodiments may be implemented by software, or by hardware or a combination of software and hardware. Taking software implementation as an example, as a logical apparatus, it is formed by reading corresponding computer program instructions from a non-volatile memory to internal storage through a processor of an electronic device where the apparatus is located. From a hardware perspective, as shown in FIG. 7, which is a structural diagram illustrating a data processing device according to an embodiment of the present disclosure, in addition to a processor, a memory, a network interface and a non-volatile memory shown in FIG. 7, the electronic device where the apparatus in the embodiments is located may usually include other hardware according to actual functions of the electronic device, which is omitted here.

Reference may be made to the data processing device shown in FIG. 7. The device may include: a processor; and a memory for storing processor executable instructions, where the processor is configured to call the executable instructions stored in the memory to implement the data processing method according to any of the embodiments as described above.

The present disclosure further provides a computer readable storage medium. The storage medium stores a computer program. The computer program is executed by a processor to implement the data processing method according to any of the embodiments as described above.

The present disclosure further provides a computer program. The computer program is stored in a storage medium. The computer program is executed by a processor to implement the data processing method according to any of the embodiments as described above.

Those skilled in the art should understand that one or more embodiments of the present disclosure may be provided as a method, a system, or a computer program product. Therefore, one or more embodiments of the present disclosure may adopt the form of a complete hardware embodiment, a complete software embodiment, or an embodiment combining software and hardware. Moreover, one or more embodiments of the present disclosure may adopt the form of a computer program product implemented on one or more computer-usable storage media (including, but not limited to, disk storage, CD-ROM, optical storage, etc.) containing computer-usable program codes.

As used herein, “and/or” means having at least one of the two, for example, “A and/or B” includes three schemes: A, B, and “A and B”.

The various embodiments in the present disclosure are described in a progressive manner, and the same or similar parts between the various embodiments may be referred to each other. Each embodiment focuses on the differences from other embodiments. In particular, as for the data processing device embodiment, since it is basically similar to the method embodiment, the description thereof is relatively simple, and reference may be made to the partial description of the method embodiment for the related parts.

The embodiments of the subject matter and functional operations described in this application may be implemented in: digital electronic circuits, tangibly embodied computer software or firmware, computer hardware including the structures disclosed in this application and structural equivalents thereof, or a combination of one or more of them. Embodiments of the subject matter described in the present disclosure may be implemented as one or more computer programs, that is, one or more modules of the computer program instructions encoded on a tangible non-transitory program carrier to be executed by a data processing device or to control the operation of the data processing device. Alternatively or additionally, the program instructions may be encoded on artificially generated propagated signals, such as machine-generated electrical, optical or electromagnetic signals, which are generated to encode information and transmit it to a suitable receiver device for execution by the data processing device. The computer storage medium may be a machine readable storage device, a machine readable storage substrate, a random or serial access memory device, or a combination of one or more of them.

The processing and logic flows described in the present disclosure may be executed by one or more programmable computers executing one or more computer programs to perform corresponding functions by operating according to input data and generating output. The processing and logic flows may also be executed by a dedicated logic circuit, such as FPGA (Field Programmable Gate Array) or ASIC (Application Specific Integrated Circuit), and the device may also be implemented as the dedicated logic circuit.

Computers suitable for executing computer programs include, for example, general-purpose and/or special-purpose microprocessors, or any other type of central processing unit. Generally, the central processing unit will receive instructions and data from a read-only memory and/or a random access memory. The basic components of a computer include a central processing unit for implementing or executing instructions and one or more memory devices for storing instructions and data. Generally, the computer will also include one or more mass storage devices for storing data, such as magnetic disks, magneto-optical disks, or optical disks, or the computer will be operatively coupled to the mass storage device to receive data from or transmit data to it, or both. However, the computer does not have to have such a device. In addition, the computer may be embedded in another device, such as a mobile phone, a personal digital assistant (PDA), a mobile audio or video player, a game console, a global positioning system (GPS) receiver, or a portable storage device such as a universal serial bus (USB) and a flash drive, for example.

Computer-readable media suitable for storing computer program instructions and data include all forms of non-volatile memory, media and memory device, including, for example, semiconductor memory devices (such as EPROMs, EEPROMs, and flash memory devices), magnetic disks (such as internal Hard disks or removable disks), magneto-optical disk and CD ROM and DVD-ROM disk. The processor and the memory may be supplemented by or incorporated into a dedicated logic circuit.

Although the present disclosure contains many specific implementation details, these should not be construed as limiting the scope of any disclosure or the scope of protection, but are mainly used to describe the features of detailed embodiments of the specific disclosure. Certain features described in multiple embodiments within the present disclosure may also be implemented in combination in a single embodiment. On the other hand, various features described in a single embodiment may also be implemented in multiple embodiments separately or in any suitable sub-combination. In addition, although features may function in certain combinations as described above and even initially claimed as such, one or more features from the claimed combination may in some cases be removed from the combination, and the claimed combination may be directed to a sub-combination or a variant of the sub-combination.

Similarly, although operations are depicted in a specific order in the drawings, this should not be understood as requiring these operations to be performed in the specific order shown or sequentially, or requiring all illustrated operations to be performed, to achieve the desired result. In some cases, multitasking and parallel processing may be advantageous. In addition, the separation of various system modules and components in the above embodiments should not be understood as requiring such separation in all embodiments, and it should be understood that the described program components and systems may usually be integrated together in a single software product, or packaged into multiple software products.

Thereby, the specific embodiments of the subject matter have been described. Other embodiments are within the scope of the appended claims. In some cases, the actions recited in the claims may be performed in a different order and may still achieve desired results. In addition, the processes depicted in the drawings do not necessarily require the specific order or sequential order shown in order to achieve the desired results. In some embodiments, multitasking and parallel processing may be advantageous.

The above descriptions are only some embodiments of the present disclosure, and are not intended to limit one or more embodiments of the present disclosure. Any modification, equivalent replacement, improvement, etc. made within the spirit and principle of one or more embodiments of the present disclosure shall be included within the protection scope of one or more embodiments of the present disclosure.

1. A computer-implemented method for data processing, comprising:
obtaining video data of a first place;
determining visit trajectories corresponding to multiple target persons according to the video data; and
determining business data according to the visit trajectories.

2. The computer-implemented method according to claim 1, further comprising:
after determining the business data, adjusting or deploying a business distribution in a target place according to the business data.

3. The computer-implemented method according to claim 2, wherein adjusting or deploying the business distribution in the target place according to the business data comprises at least one of:
adjusting the business distribution in the target place, wherein the target place comprises the first place or a second place different from the first place; or
deploying the business distribution in a third place different from the first place.

4. The computer-implemented method according to claim 2, wherein adjusting the business distribution in the target place according to the business data comprises at least one of:
increasing a number of businesses in the target place where a number of target persons who came to visit reaches a first threshold;
reducing a number of businesses in the target place where a number of target persons who came to visit is below a second threshold;
increasing a number of businesses that conform to attributes of target persons; or
reducing a number of businesses that fail to conform to attributes of target persons.

5. The computer-implemented method according to claim 1, wherein the business data comprises at least one of:
data indicating an association relationship between different businesses;
data indicating an association relationship between different sub-businesses in a same business; or
data indicating an association relationship between sub-businesses belonging to different businesses.

6. The computer-implemented method according to claim 1, wherein determining the business data according to the visit trajectories comprises at least one of:
determining, according to the visit trajectories, businesses visited by at least one of the multiple target persons within a first preset time period, and determining, according to the businesses visited by the at least one of the multiple target persons, a number of persons visiting each business combination, wherein a business combination indicates two different businesses in the first place; or
determining, according to the visit trajectories, sub-businesses visited by at least one of the multiple target persons within a second preset time period, and determining, according to the sub-businesses visited by the at least one of the multiple target persons, a number of persons visiting at least one of each business combination or each sub-business combination, wherein a sub-business combination indicates two different sub-businesses in the first place.

7. The computer-implemented method according to claim 1, wherein, after determining the business data, the computer-implemented method comprises at least one of:
determining businesses included in business combinations, where a number of target persons who came to visit within a first preset time period reaches a third threshold, as target businesses for linkage marketing; or
determining sub-businesses included in sub-business combinations, where a number of target persons who came to visit within a second preset time period reaches a fourth threshold, as target sub-businesses for linkage marketing.

8. The computer-implemented method according to claim 1, wherein the business data comprises at least one of:
data on target person flow comparison between business operation regions corresponding to respective businesses;
data on target person flow comparison between respective businesses;
data on target person flows corresponding to respective businesses within different time periods;
data on target person flows corresponding to business operation regions corresponding to respective businesses within different time periods;
data on a ratio of a number of target persons visiting business operation regions corresponding to respective businesses to a total number of target persons who came to visit;
data on a ratio of a number of target persons visiting respective businesses to a total number of target persons who came to visit;
data on a trend of target person flow changes corresponding to respective businesses;
data on a trend of target person flow changes corresponding to business operation regions corresponding to respective businesses;
data on attribute distribution of target persons visiting business operation regions corresponding to respective businesses; or
data on attribute distribution of target persons visiting respective businesses.

9. The computer-implemented method according to claim 1, wherein determining the visit trajectories corresponding to the multiple target persons according to the video data comprises:
identifying target persons appearing in multiple video streams corresponding to the first place;
determining regions where the target persons are located in the multiple video streams; and
reproducing visit trajectories corresponding to the target persons according to the determined regions.

10. The computer-implemented method according to claim 9, wherein identifying the target persons appearing in the multiple video streams corresponding to the first place comprises:
extracting person features corresponding to persons appearing in the multiple video streams;
obtaining person features matching the extracted person features from a person feature library; and
determining persons corresponding to the obtained person features as the target persons.

11. The computer-implemented method according to claim 9, wherein determining the regions where the target persons are located in the multiple video streams comprises:
determining position coordinates of the target persons in a plane view including the first place based on calibration parameters of image capturing devices that capture target video streams in which the target persons appear; and
determining regions corresponding to the position coordinates of the target persons in the plane view as the regions where the target persons are located in the multiple video streams.

12. The computer-implemented method according to claim 9, wherein determining the regions where the target persons are located in the multiple video streams comprises:
determining, according to positions of image capturing devices that capture target video streams in which the target persons appear, regions corresponding to the image capturing devices as the regions where the target persons are located in the multiple video streams.

13. The computer-implemented method according to claim 9, further comprising:
determining visiting time periods of the target persons visiting the regions according to capturing time information of target video streams, among the multiple video streams, in which the target persons appear.

14. The computer-implemented method according to claim 1, wherein the first place comprises at least one of commercial streets, shopping malls, hypermarkets, or shops, and
wherein the target persons comprise at least one of visitors, customers, or members.

15. Anon-transitory computer readable storage medium coupled to at least one processor and having machine-executable instructions stored thereon that, when executed by the at least one processor, cause the at least one processor to perform operations comprising:
obtaining video data of a first place;
determining visit trajectories corresponding to multiple target persons according to the video data; and
determining business data according to the visit trajectories.

16. A data processing device, comprising:
at least one processor; and
one or more memories coupled to the at least one processor and storing programming instructions for execution by the at least one processor to perform operations comprising:
obtaining video data of a first place;
determining visit trajectories corresponding to multiple target persons according to the video data; and
determining business data according to the visit trajectories.

17. The data processing device according to claim 16, wherein determining the visit trajectories corresponding to the multiple target persons according to the video data comprises:
identifying target persons appearing in multiple video streams corresponding to the first place;
determining regions where the target persons are located in the multiple video streams; and
reproducing visit trajectories corresponding to the target persons according to the determined regions.

18. The data processing device according to claim 17, wherein identifying the target persons appearing in the multiple video streams corresponding to the first place comprises:
extracting person features corresponding to persons appearing in the multiple video streams;
obtaining person features matching the extracted person features from a person feature library; and
determining persons corresponding to the obtained person features as the target persons.

19. The data processing device according to claim 17, wherein determining the regions where the target persons are located in the multiple video streams comprises:
determining position coordinates of the target persons in a plane view including the first place based on calibration parameters of image capturing devices that capture target video streams in which the target persons appear; and
determining regions corresponding to the position coordinates of the target persons in the plane view as the regions where the target persons are located in the multiple video streams.

20. The data processing device according to claim 17, wherein determining the regions where the target persons are located in the multiple video streams comprises:
determining, according to positions of image capturing devices that capture target video streams in which the target persons appear, regions corresponding to the image capturing devices as the regions where the target persons are located in the multiple video streams.
